(19) United States
(12) Patent Application Publication
(10) Pub. No.: US 2018/0290900 A1
(43) Pub. Date: Oct. 11, 2018

(54) FLUID STERILIZATION DEVICE AND WATER PURIFIER USING THE SAME

(71) Applicant: INDUSTRIAL TECHNOLOGY RESEARCH INSTITUTE, Chutung (TW)

(72) Inventors: Chien-Chun LU, New Taipei City (TW); Chen-Peng HSU, Kaohsiung City (TW); Karthickraj Muthuramalingam, Hsinchu City (TW); Yi-Keng FU, Hukou Township (TW); Chieh Lee, Sanyi Township (TW)

(21) Appl. No.: 15/940,552

(22) Filed: Mar. 29, 2018

Related U.S. Application Data
(60) Provisional application No. 62/479,341, filed on Mar. 31, 2017.
(60) Provisional application No. 62/549,448, filed on Aug. 24, 2017.

(30) Foreign Application Priority Data
Dec. 28, 2017 (TW) 106146181

(51) Int. Cl. C02F 1/32

(52) U.S. Cl. CPC C02F 1/325; C02F 2201/002; C02F 2201/3227; C02F 2201/326

(57) ABSTRACT

A fluid sterilization device including a reaction chamber body, a light source, a fluid sensor and a controller is provided. The reaction chamber body has a reaction chamber through which a fluid passes. The light source is used to emit a light to the reaction chamber. The fluid sensor is used to detect the passage of the fluid and accordingly output. The controller is used to control the light source to emit the light in response to the signal.

This application claims the benefit of U.S. provisional application Ser. No. 62/479,341, filed Mar. 31, 2017, U.S. provisional application Ser. No. 62/549,448, filed Aug. 24, 2017, and Taiwan application Serial No. 106146181, filed Dec. 28, 2017, the subject matters of which are incorporated herein by references.

### TECHNICAL FIELD

The disclosure relates in general to a fluid sterilization device and a water purifier using the same, and more particularly to a fluid sterilization device having a fluid sensor and a water purifier using the same.

### BACKGROUND

Conventional sterilization device is normally equipped with a light source. The light source emits sterilization light to sterilize the fluid passing through. Most light sources adopt mercury lamp which requires a warm-up time to provide the sterilization function. Thus, the mercury lamp normally emits the light 24 hours a day. However, such design results in a large amount of electric power consumption.

### SUMMARY

According to one embodiment, a fluid sterilization device including a reaction chamber body, a light source, a fluid sensor and a controller is provided. The reaction chamber body has a reaction chamber, a first end and a second end through which a fluid passes. The first light source is located at the first end of the reaction chamber and is used to emit a first light to the reaction chamber. The fluid sensor is used to detect the passage and flow rate of the fluid and accordingly output a signal. The controller is used to control the first light source to output the first light and control the intensity of the light emitted from the first light source in response to the signal.

According to another embodiment, a water purifier is provided. The water purifier includes at least two fluid sterilization devices disclosed above. After the fluid is sterilized by one of the fluid sterilization devices, the fluid is filtered by a filter cartridge, and the filtered fluid passes flows through another fluid sterilization device.

The above and other aspects of the disclosure will become better understood with regard to the following detailed description of the preferred but non-limiting embodiment (s). The following description is made with reference to the accompanying drawings.

### BRIEF DESCRIPTION OF THE DRAWINGS

FIG. 1A shows a schematic diagram of a fluid processing device according to an embodiment of the present disclosure.

FIG. 1B shows a top view of the fluid processing device of FIG. 1A.

FIGS. 2A and 2C show schematic diagrams of an application example of a fluid processing device according to an embodiment of the present disclosure.

FIGS. 3A and 3B show schematic diagrams of other application examples of a fluid processing device according to an embodiment of the present disclosure.

FIG. 4A shows a schematic diagram of a fluid processing device according to another embodiment of the present disclosure.

FIG. 4B shows a cross-sectional view of the fluid processing device of FIG. 4A along a cross-sectional line 4B-4B′.

FIG. 4C shows a top view of the fluid processing device of FIG. 4A.

FIG. 4D shows a 3D diagram of a flow disturbing component according to another embodiment of the present disclosure.

FIG. 5 shows a functional block diagram of a fluid processing device according to an embodiment of the present disclosure.

FIG. 6 shows a schematic diagram of an application example of a fluid processing device according to an embodiment of the present disclosure.

FIG. 7 shows a schematic diagram of another application example of a fluid processing device according to another embodiment of the present disclosure.

FIG. 8 shows a cross-sectional view of a fluid processing device according to another embodiment of the present disclosure.

FIG. 9A shows a schematic diagram of a fluid sensor according to another embodiment of the present disclosure.

FIG. 9B shows a cross-sectional view of the fluid sensor of FIG. 9A along a direction 9B-9B′.

FIG. 9C shows a schematic diagram of the blades of FIG. 9A.

FIG. 9D shows a top view of the blades of FIG. 9C.

FIG. 9E shows a top view of the magnet component of FIG. 9C.

FIG. 10A shows a schematic diagram of a fluid sterilization device according to another embodiment of the present disclosure.

FIG. 10B shows a cross-sectional view of the fluid sterilization device of FIG. 10A along a direction 10B-10B′.

FIG. 11A shows a schematic diagram of a fluid sterilization device according to another embodiment of the present disclosure.

FIG. 11B shows a cross-sectional view of the fluid sterilization device of FIG. 11A along a direction 11B-11B′.

FIGS. 11C and 11D show schematic diagrams of the first light-emitting cap of FIG. 11A.

FIG. 11E shows a cross-sectional view of the first light-emitting cap of FIG. 11C along a direction 11E-11E′.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

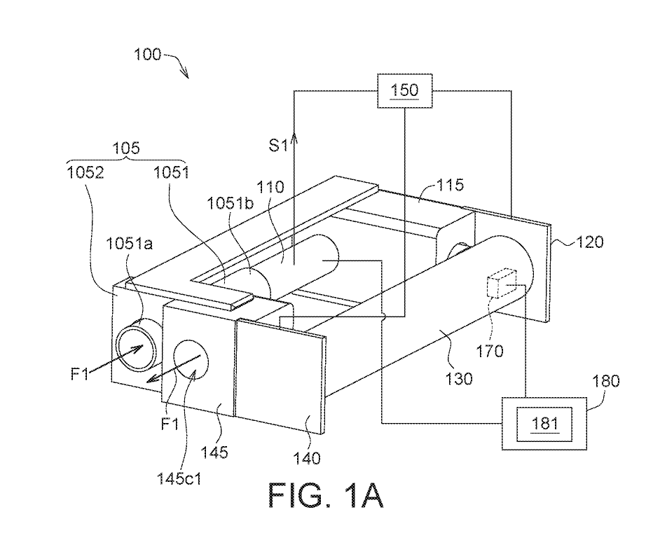

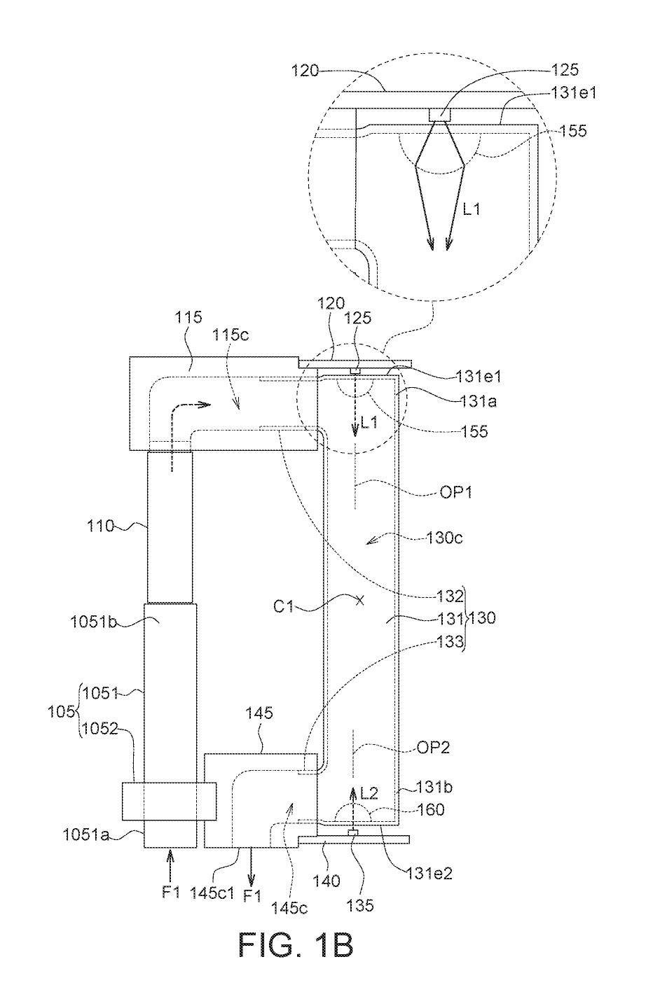

Refer to FIGS. 1A and 1B. FIG. 1A shows a schematic diagram of a fluid processing device 100 according to an embodiment of the present disclosure. FIG. 1B shows a top view of the fluid processing device 100 of FIG. 1A.

The fluid processing device 100 includes a transmission tubular piece 105, a fluid sensor 110, a first heat conduction component 115, a first circuit board 120, a first light source 125, a reaction chamber body 130, a second light source 135, a second circuit board 140, a second heat conduction component 145, a controller 150, a first lens 155 and a second lens 160.

The reaction chamber body 130 has a reaction chamber 130c through which a fluid F1 passes. The first light source 125 is used to emit a first light L1 to the reaction chamber 130c. The fluid sensor 110 is used to detect the passage and flow rate of the fluid F1 and accordingly output a signal S1. The controller 150 controls the first light source 125 to emit the first light L1 and/or controls the second light source 135 to emit a second light L2 in response to the signal S1. For example, when the fluid sensor 110 detects that the flow rate of the fluid F1 is over a limit, the fluid sensor 110 outputs a signal S1. The signal S1 can be an activation signal which informs the controller 150 to activate the first light source 125 to emit the first light L1 and/or activate the second light source 135 to emit the second light L2. In another embodiment, the fluid sensor 110 detects the flow rate of the fluid F1, and outputs a signal S1 which can be a flow rate signal. The controller 150 receives the signal S1, and determines whether the flow rate of the fluid is over a limit. If the flow rate of the fluid is over the limit, the controller 150 activates the first light source 125 to emit the first light L1 and/or activate the second light source 135 emit the second light L2. In another embodiment, the fluid sensor 110 detects the flow rate of the fluid F1, and accordingly outputs a signal S1, which can be a flow rate signal. The controller 150 receives the signal S1, and determines the intensity of the first light L1 emitted from the first light source 125 and/or the intensity of the second light L2 emitted from the second light source 135 according to the flow rate of the fluid F1. For example, when the flow rate of the fluid F1 is high, the controller 150 increases the intensity of the first light L1 emitted from the first light source 125 and/or the intensity of the second light L2 emitted from the second light source 135. When the flow rate of the fluid F1 is low, the controller 150 decreases the intensity of the first light L1 emitted from the first light source 125 and/or the intensity of the second light L2 emitted from the second light source 135.

In an embodiment, the first light source 125 and the second light source 135 can be UV light sources, and the first light L1 and the second light L2 emitted from the first light source 125 and the second light source 135 have sterilization (or disinfection) function. To summarize, the fluid processing device 100 of the embodiments of the present disclosure can automatically detect the passage of the fluid F1 and automatically activate the sterilization function. Thus, the sterilization light does not need to continuously irradiate 24 hours a day, and electric power consumption can be reduced. Moreover, the fluid F1 can be a gas or a liquid, wherein the fluid refers to the flowing water or the tap water, and the gas refers to air, oxygen, and so on.

In other embodiments, the light emitted from the first light source 125 and/or the second light source 135 is not limited to the sterilization light. For example, the fluid F1 within the reaction chamber 130c can be ozone, and the light emitted from the first light source 125 and/or the second light source 135 can let the gas to generate chemical reaction such as cracking ozone to generate oxygen. In other embodiments, the chamber wall of the reaction chamber 130c can be coated with photo catalyst, and the fluid F1 within the reaction chamber 130c can be an organic gas.

It can be understood from the above disclosure that the fluid processing device of the embodiments of the present disclosure can be a fluid sterilization device or a fluid reaction device.

In another embodiment, the first light source 125 and/or the second light source 135 can be light-emitting diodes or other suitable light-emitting elements, and the first light L1 and/or the second light L2 emitted from the first light source 125 and/or the second light source 135 can be UV light having bactericidal effect. In comparison to the mercury lamp, the light-emitting diode has the advantages of quicker startup, smaller volume and lower electric power consumption. The chamber wall of the reaction chamber 130c can be coated with a material having high reflectivity towards the first light L1 and/or the second light L2. For example, the chamber wall is coated with a metal material having high reflectivity towards the UV light.

Detailed descriptions of the structure of the fluid processing device 100 are disclosed below.

As indicated in FIGS. 1A and 1B, the transmission tubular piece 105 connects the first heat conduction component 115 and the second heat conduction component 145. The transmission tubular piece 105 includes a transmission tube 1051 and a flange 1052, wherein the transmission tube 1051 passes through the flange 1052. The flange 1052 and the second heat conduction component 145 can be fixed together by way of engaging, welding or bonding, so that relative position between the transmission tube 1051 and the second heat conduction component 145 can also be fixed. The transmission tube 1051 has a first end 1051a and a second end 1051b, wherein the first end 1051a can receive the input of the fluid F1, and the second end 1051b is connected to the fluid sensor 110. In another embodiment, depending on the position of the second heat conduction component 145, the flange 1052 does not have to be connected to the second heat conduction component 145. The shape of the transmission tube 1051 is dependent on the flow path and is not subjected to specific restriction in the embodiments of the present disclosure.

As indicated in FIG. 1A, in the present embodiment, the opening of the first end 1051a of the transmission tube 1051 can be used as a fluid inlet, and the opening 145c1 of the second heat conduction component 145 can be used as a fluid outlet. In another embodiment, the opening of the first end 1051a of the transmission tube 1051 can be used as a fluid outlet, and the opening 145c1 of the second heat conduction component 145 can be used as a fluid inlet.

The fluid sensor 110 connects the transmission tube 1051 of the transmission tubular piece 105 and the reaction chamber body 130. Thus, when the fluid F1 enters the fluid processing device 100 via the first end 1051a of the transmission tube 1051, the fluid sensor 110 detects the passage of the fluid F1 and accordingly outputs a signal S1. The controller 150 S1 controls the first light source 125 to emit a first light L1 and/or the second light source 135 to emit a second light L2 to the reaction chamber 130c to activate the sterilization function in response to the signal.

The first heat conduction component 115 has a first channel 115c through which the fluid F1 passes. The first circuit board 120 is connected to the first heat conduction component 115. The first light source 125 is electrically connected to the first circuit board 120. Thus, the heat generated from the irradiation of the first light source 125 can firstly be transferred to the first heat conduction component 115 through the first circuit board 120. Then, the heat is transferred to the fluid F1 within the first channel 115c. Lastly, the heat is dissipating to the exterior with the fluid F1. Thus, the fluid processing device 100 of the present embodiment can transfer the heat through the fluid F1. Since the fluid F1 circulates and forms a cycle with the exterior, the fluid processing device 100 can provide a high efficiency of heat dissipation. Also, after the fluid F1 enters the fluid processing device 100 and the fluid sensor 110 detects the passage of the fluid F1, the first light source 125 emits the first light L1 and the fluid immediately provide a heat-dissipating function as it passes by. The first light source 125 does not emit the first light L1 unless the fluid F1 enters the fluid processing device 100, so the electric power consumption of the fluid processing device 100 can be saved.

In the present embodiment, the fluid F1 within the first channel 115c of the first heat conduction component 115 can directly contact the inner wall of the first channel 115c to increase the efficiency of heat transfer. In another embodiment, the fluid sensor 110 and/or the reaction chamber body 130 can extend to the first channel 115c. Thus, the fluid F1 does not need to contact the inner wall of the first channel 115c, but the heat carried by the fluid F1 still can be ventilated and transferred to the first heat conduction component 115. Moreover, the first heat conduction component 115 can be formed of metal, such as copper or other materials with high conductivity.

As indicated in FIGS. 1A and 1B, the first circuit board 120 of the present embodiment is directly connected to the first heat conduction component 115, so that the heat resistance between the first circuit board 120 and the first heat conduction component 115 can be reduced, the path of heat transfer can be shortened, and the efficiency of heat dissipation can be increased.

As indicated in FIG. 1B, the reaction chamber body 130 includes a first tube 131, a second tube 132 and a third tube 133. The reaction chamber 130c is defined as an interior space of the first tube 131. The first tube 131 has a first end 131a and a second end 131b opposite to the first end 131a. The reaction chamber body 130 is a translucent chamber body. The first light source 125 faces the first end wall 131e1 of the first end 131a, so that the first light L1 emitted from the first light source 125 can enter the first tube 131 of the reaction chamber body 130 through the first end wall 131e1 to sterilize the fluid F1 within the reaction chamber body 130. Since the first tube 131 is a straight tube (that is, the first tube 131 is not bent or curved), the optical axis OP1 of the first light L1 has a direction substantially parallel to the extending direction of the first tube 131 of the reaction chamber body 130, and the fluid F1 flowing between the first end 131a and the second end 131b can all be irradiated by the first light L1.

Similarly, the second end 131b of the first tube 131 of the reaction chamber body 130 has a second end wall 131e2. The second light source 135 faces the second end wall 131e2 of the second end 131b, so that the second light L2 emitted from the second light source 135 can enter the first tube 131 of the reaction chamber body 130 through the second end wall 131e2 to sterilize the fluid F1 within the reaction chamber body 130. Since the first tube 131 is a straight tube, the optical axis OP2 of the second light L2 has a direction substantially parallel to the extending direction of the first tube 131 of the reaction chamber body 130, and the fluid F1 flowing between the second end 131b and the first end 131a can all be irradiated by the second light L2.

Since both the first end 131a and the second end 131b of the first tube 131 can be irradiated by the light, the central position C1 between the first end 131a and the second end 131b has a larger intensity of the light (in comparison to the situation when only one end is irradiated by the light). In other words, the sterilization performance of the sterilization light at the central position C1 between the first end 131a and the second end 131b isn't decreased despite that the central position C1 is farther away from the light source than the two ends. Furthermore, the fluid processing device 100 of the embodiments of the present disclosure adopts the design of double-ended irradiation. In comparison to the design of single-ended irradiation, the double-ended irradiation irradiates a larger area of the fluid F1 and produces a higher sterilization rate for the fluid F1 having high concentration of bacterium.

As indicated in FIG. 1B, the second tube 132 is non-parallelly connected to the first end 131a of the first tube 131 to connect the first heat conduction component 115, so that the fluid F1 within the first heat conduction component 115 can be interconnected with the reaction chamber body 130 through the second tube 132. In an embodiment, the second tube 132 and the first tube 131 can be connected to form an L-shape. That is, the angle between the second tube 132 and the first tube 131 is substantially 90°. However, the angle can have other angular values. In another embodiment, the second tube 132 can pass through the first channel 115c and extend to connect the fluid sensor 110. Under such design, the second tube 132 can directly contact the inner wall surface of the first channel 115c to reduce the heat resistance between the second tube 132 and the inner wall surface of the first channel 115c of the first heat conduction component 115.

Furthermore, the third tube 133 is non-parallelly connected to the second end 131b of the first tube 131 to connect the second heat conduction component 145, so that the fluid F1 within the first tube 131 can be interconnected with the second heat conduction component 145 through the third tube 133. In an embodiment, the third tube 133 and the first tube 131 can be connected to form an L-shape. That is, the angle between the third tube 133 and the first tube 131 is substantially 90°. However, the angle can have other angular values. In another embodiment, the third tube 133 can pass through the second channel 145c of the second heat conduction component 145. Under such design, the third tube 133 can directly contact the inner wall surface of the second channel 145c to reduce the heat resistance between the third tube 133 and the inner wall surface of the first channel 115c of the second heat conduction component 145.

As indicated in FIG. 1B, the first tube 131, the second tube 132 and the third tube 133 can be arranged as a U-shape. In another embodiment, depending on the positions of the first heat conduction component 115 and the second heat conduction component 145, the reaction chamber body 130 can have other shape such as an S-shape. In an embodiment, the first tube 131, the second tube 132 and/or the third tube 133 can be straight tubes, bent tubes or a combination thereof to match the positions of the first heat conduction component 115 and the second heat conduction component 145 and to form different geometric shapes. Besides, the first tube 131, the second tube 132 and the third tube 133 can be integrally formed in one piece.

As indicated in FIG. 1B, the first lens 155 is disposed within the first tube 131 of the reaction chamber body 130 and opposite to the first light source 125, so that the first light L1 emitted from the first light source 125 can pass through the first lens 155. For example, the first lens 155 is disposed on an opposite side of the first end wall 131e1, and the first light L1 can be focused by the first lens 155 to increase the directivity of the first light L1.

Similarly, as indicated in FIG. 1B, the second lens 160 is disposed within the first tube 131 of the reaction chamber body 130 and opposite to the second light source 135, so that the second light L2 emitted from the second light source 135 can pass through the second lens 160. For example, the second lens 160 is disposed on an opposite side of the second end wall 131e2, and the second light L2 can be focused by the second lens 160 to increase the directivity of the second light L2.

In an embodiment, the first lens 155, the second lens 160 and the first tube 131 can be integrally formed in one piece. For example, the first lens 155 or/and the second lens 160 can constitute a portion of the tube wall of the first tube 131. That is, the first lens 155 constitutes the first end wall 131e1 of the first end 131a of the reaction chamber body 130, and the second lens 160 constitutes the second end wall 131e2 of the second end 131b of the reaction chamber body 130. The light emitted from the first light source 125 and the light emitted from the second light source 135 can pass through the lens-like first end wall 131e1 and second end wall 131e2 respectively to reduce the optical loss which occurs when the passes through an interface. In other embodiments, the first lens 155 and/or the second lens 160 can be formed separately and then are engaged or adhered on the first tube 131 by using a bonding technology. Furthermore, the first lens 155 has an incident surface, which can be a convex surface, a concave surface, a planar surface, or a combination thereof. Similarly, the second lens 160 has an incident surface is similar or identical to the incident surface of the first lens 155, and the similarities are not repeated here.

As indicated in FIG. 1B, the second heat conduction component 145 has a second channel 145c through which the fluid F1 passes. The second circuit board 140 is connected to the second heat conduction component 145. The second light source 135 is electrically connected to the second circuit board 140. Thus, the heat generated from the irradiation of the second light source 135 can firstly be transferred to the second heat conduction component 145 through the second circuit board 140. Then, the heat is transferred to the fluid F1 within the second channel 145c. Lastly, the heat is dissipating to the exterior with the fluid F1. Thus, the fluid processing device 100 of the present embodiment can transfer the heat through the fluid F1. Since the fluid F1 circulates and forms a cycle with the exterior, the fluid processing device 100 can provide a high efficiency of heat dissipation. Also, when the second light source 135 emits the second light L2 (the second light source 135 starts to generate heat), this implies that the fluid F1 already enters the fluid processing device 100 and can immediately provide a heat-dissipating function. The second light source 135 does not emit the second light L2 unless the fluid F1 enters the fluid processing device 100, so the electric power consumption of the fluid processing device 100 can be saved.

In the present embodiment, the fluid F1 within the second channel 145c of the second heat conduction component 145 can directly contact the inner wall of the second channel 145c to increase the efficiency of heat transfer. In another embodiment, the third tube 133 of the reaction chamber body 130 can extend to the second channel 145c. Thus, the fluid F1 does not contact the inner wall of the second channel 145c, but the heat carried by the fluid F1 still can be ventilated and transferred to the second heat conduction component 145.

As indicated in FIGS. 1A and 1B, the second heat conduction component 145 has an opening 145c1 from which the sterilized fluid F1 can flow out. In another embodiment, the third tube 133 can extend to the outside of the opening 145c1 or near the opening 145c1, but the embodiments of the present disclosure are not limited thereto. Moreover, the second heat conduction component 145 can be formed of a metal, such as copper or other material with high conductivity.

The fluid processing device 100 can be electric powered by an external electric power supply or an internal electric power storage device (not illustrated) such as battery. The electric power storage device can be a solar cell, which receives the light of solar energy and then converts the light into electric power and stores it in the electric power storage device. In other embodiments, the electric power storage device can store the electric power generated from the work performed on the electric power generator by a fluid, such as water flow or gas flow.

As indicated in FIG. 1A, the fluid processing device 100 further includes a light intensity sensor 170 and a wireless output device 180. The light intensity sensor 170 is disposed within the reaction chamber body 130 to detect the intensities of the first light L1 and the second light L2. The wireless output device 180 has a display panel 181 on which the flow rates detected by the fluid sensor 110 and the light intensities detected by the light intensity sensor 170 are displayed.

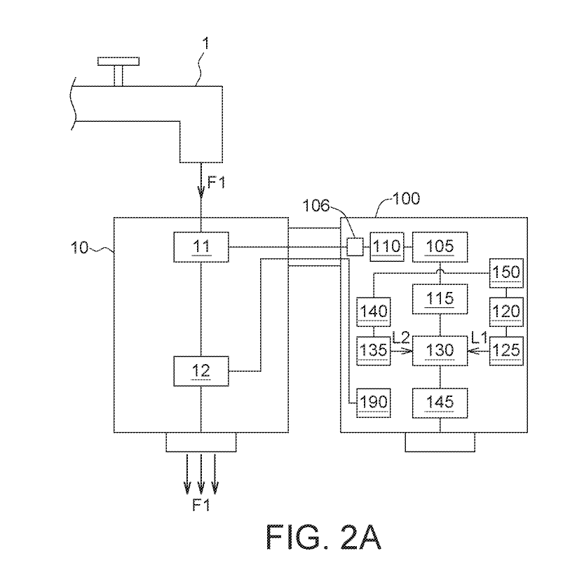

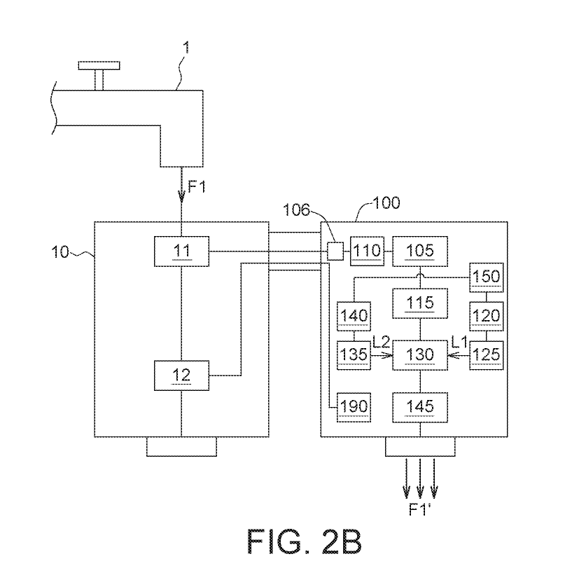

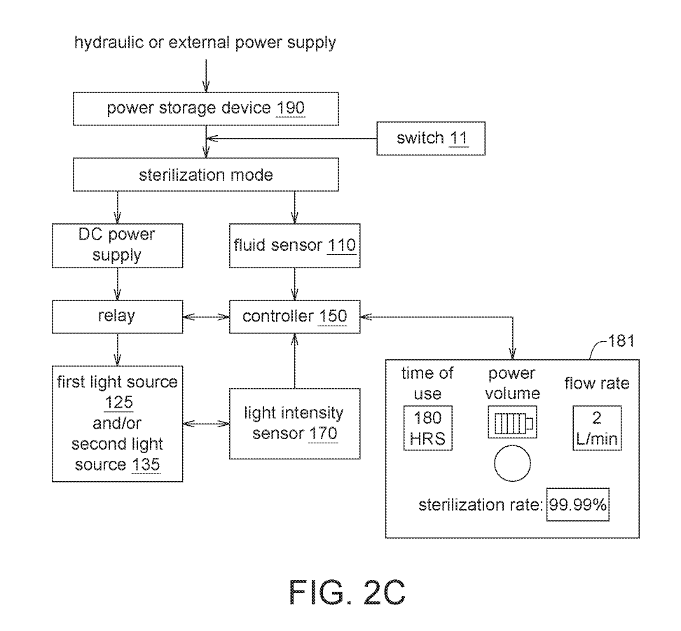

Refer to FIGS. 2A-2C, schematic diagrams of an application example of a fluid processing device 100 according to an embodiment of the present disclosure are shown. The fluid processing device 100 is disposed on the chamber 10. The chamber 10 can be installed in a water source 1, such as a faucet. The chamber 10 at least includes a switch 11 and an electric power generator 12. The fluid processing device 100 further includes an electric power storage device 190. The switch 11 can selectively switch the fluid F1 of the water source 1 to the electric power generator 12 or the fluid processing device 100.

As indicated in FIG. 2A, when the switch 11 switches the fluid F1 to the electric power generator 12, the fluid F1 performs work on the electric power generator 12 to generate electric power. The electric power can be stored in the electric power storage device 190 of the fluid processing device 100 to provide necessary electric power to the first light source 125, the second light source 135 and/or any other elements of the fluid processing device 100. The fluid F1 exited from the electric power generator 12 can be used in general purpose such as hand wash or fruit and vegetable wash.

As indicated in FIG. 2B, when the switch 11 switches the fluid F1 to the fluid processing device 100, the fluid F1 sequentially passes through the fluid sensor 110, the transmission tubular piece 105, the first heat conduction component 115, the reaction chamber body 130 and the second heat conduction component 145. The fluid F1 within the reaction chamber body 130 is irradiated by the first light source 125 and the second light source 135 and become a sterilized fluid F1′ which can be used in purposes different from that of the unsterilized fluid F1. For example, the sterilized fluid F1′ can be used to clean burned or wounded part of human body or can be used in other treatments that require bacteria-free or bacteria less water. As indicated in FIG. 2B, the fluid F1 is filtered by a filter cartridge 106 before passing through the fluid sensor 110. In another embodiment, the filter cartridge 106 can be disposed in the downstream of the fluid sensor 110, so that the fluid F1 is filtered by the fluid sensor 110 before passing through the filter cartridge 106.

As indicated in FIG. 2C, when the switch 11 switches the fluid F1 to the fluid processing device 100, the fluid sensor 110 detects the passage of the fluid F1, and the controller 150 activates a sterilization mode accordingly. Meanwhile, the electric power stored in the electric power storage device 190 is provided to the first light source 125 and/or the second light source 135 through the electrical relay, so that the first light source 125 and/or the second light source 135 can emit the light. The relay can be disposed between the electric power storage device 190 and the light source. The fluid sensor 110 and the light intensity sensor 170 are electrically connected to the controller 150 to transmit a signal to the controller 150, which performs relevant processing according to the received signal.

It can be understood from the above disclosure that the switch 11 can switch the fluid F1 of the water source 1 to the electric power generator 12 or the fluid processing device 100. Thus, when the sterilized fluid F1′ is required, the switch 11 can immediately switch the fluid F1 to the fluid processing device 100 to quickly obtain the sterilized fluid F1′ for emergent use (such as the treatment of burn injury in the hospital).

As indicated in FIG. 2C, the display panel 181 is electrically connected to the controller 150. The controller 150 can display the detection results, such as the flow rate detected by the fluid sensor 110 and the intensity of the light detected by the light intensity sensor 170, on the display panel 181. The time of use, the electric power volume and/or the sterilization rate can also be displayed on the display panel 181. Data, such as the flow rate of the fluid, the intensity of the light, the time, the electric power volume and/or the sterilization rate, can also be stored in the controller 150. The controller 150 can calculate according to the above data to determine exemplary parameters for the fluid processing device 100. For example, to achieve a sterilization rate of 90%, the controller 150 can calculate the required intensity of the light for the fluid with a particular flow rate or the required flow rate of the fluid for a particular light intensity. Based on the concept of the Internet of Things (IoT), the flow rate of the fluid, the intensity of the light, the time of use, the electric power volume and/or the sterilization rate of multiple fluid processing devices 100 can be collected and stored in a remote cloud processor. The cloud processor can compare the data received from individual fluid processing device 100 with the big data of other fluid processing devices and calculate exemplary parameters for individual fluid processing device 100. For example, to achieve a sterilization rate of 90%, the cloud processor can calculate the required intensity of the light for the fluid with a particular flow rate or the required flow rate of the fluid for a particular intensity of the light. For example, the fluid processing device 100 at a particular region transmits the GPS coordinates of its location to the cloud processor, and the cloud processor can compare the data received from the fluid processing devices 100 near the location and calculate exemplary parameters for the fluid processing device 100 at the particular region.

To summarize, the controller 150 can calculate the flow rate of the fluid and the intensity of the light that are required to achieve a fixed sterilization rate according to at least one of the above data. Or, the fluid processing device 100 can store at least one of the above data in a cloud processor which can compare the stored big data and calculate the flow rate of the fluid and the intensity of the light that are required to achieve a fixed sterilization rate.

When the electric power of the fluid processing device 100 is insufficient, the controller 150 can transmit the message “Insufficient Electric power” to the display panel 181 to remind the user to replace or charge the electric power storage device.

In another embodiment, the display panel 181 is disposed in an external electronic device. The controller 150 can transmit the message of the fluid processing device 100 to the display panel 181 of an external electronic device through wireless communication such as WiFi or Bluetooth. The external electronic device is such as a computer or a mobile phone. Thus, the fluid processing device can be monitored through an application program (App) of the mobile phone.

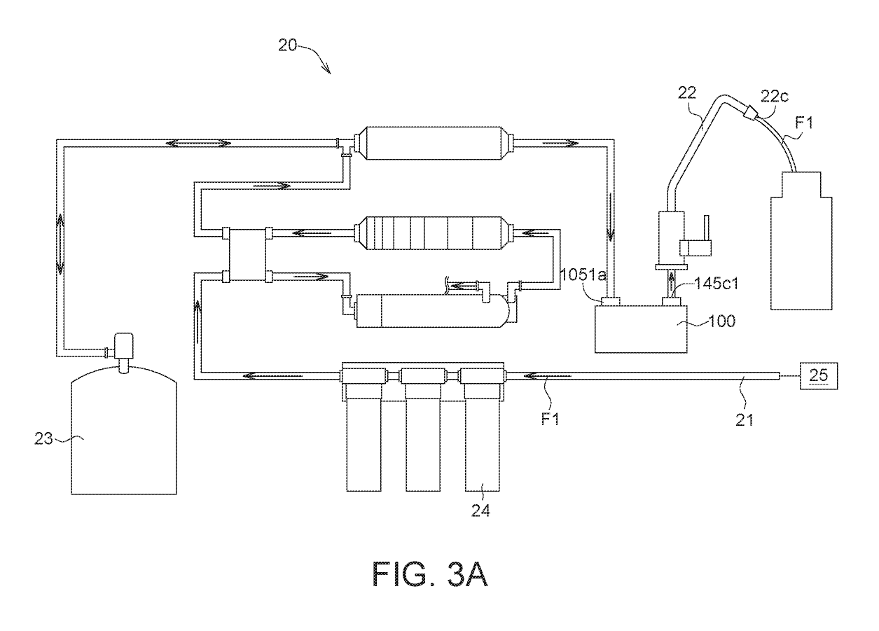

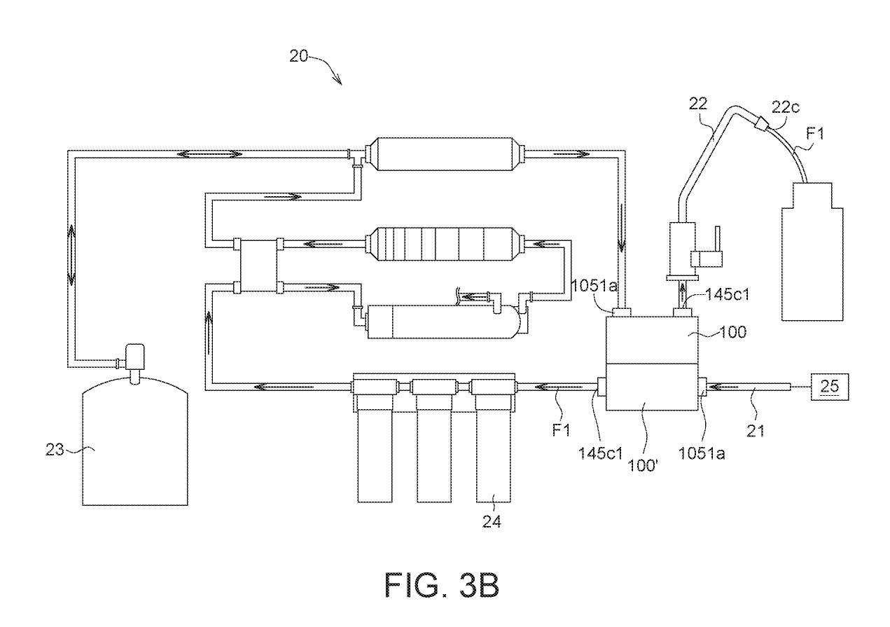

Refer to FIGS. 3A-3B, schematic diagrams of other application examples of a fluid processing device 100 according to an embodiment of the present disclosure are shown.

As indicated in FIG. 3A, the fluid processing device 100 can be disposed in the flow path of the water purifier 20. The water purifier 20 at least includes a water inlet tube 21, a water outlet tube 22, a water tank 23 and a filter cartridge 24. The fluid F1 of the water source 25 enters the water purifier 20 via the water inlet tube 21 to be filtered by the filter cartridge 24. Then, the filtered fluid F1 is stored in the water tank 23 via relevant tubes. As indicated in the diagram, the fluid processing device 100 can be disposed near the water outlet tube 22. In detail, the opening (fluid inlet) of the first end 1051a of the fluid processing device 100 is connected to the water tank 23, and the opening 145c1 (fluid outlet) is connected to the water outlet tube 22. Thus, after the fluid F1 within the water tank 23 is sterilized by the fluid processing device 100, the sterilized fluid F becomes safe drinking water available for use when the fluid F exits from the outlet of the water outlet tube 22. Also, since the outlet 22c of the water outlet tube 22 is exposed in the air, bacterium may easily enter the water outlet tube 22 via the outlet 22c. The fluid processing device 100 can sterilize the bacterium entering the water outlet tube 22 via the outlet 22c and reduce the bacterium breeding in the pipe.

As indicated in FIG. 3B, the fluid processing device 100 and another fluid processing device 100′ can be connected to form a set of fluid processing devices, wherein the fluid processing device 100 is adjacent to the water outlet tube 22, and the fluid processing device 100′ is adjacent to the water inlet tube 21. The structure of the fluid processing device 100′ is similar or identical to that of the fluid processing device 100, and the similarities are not repeated here. As indicated in the diagram, the opening (fluid inlet) of the first end 1051a of the fluid processing device 100′ is connected to the water source 25, such as an unsterilized water source (such as tap water) or a polluted water source, and the opening 145c1 (fluid outlet) is connected to the filter cartridge 24. Thus, the fluid F1 coming from the water source 25 is firstly sterilized by the fluid processing device 100′, then the sterilized fluid F1 is filtered by the filter cartridge 24, and lastly the filtered fluid F1 is stored in the water tank 23 via a tube.

As indicated in FIG. 3B, the water purifier 20 can be realized by a reverse osmosis system. After the fluid F1 is processed with a first sterilization process by the fluid processing device 100′, the fluid F1 is processed with a reverse osmosis treatment. Before the fluid F1 is used for drinking purpose, the fluid F1 is further processed with a second sterilization process by the fluid processing device 100. Thus, the fluid F1 can achieve a bactericidal effect of 99.9 above.

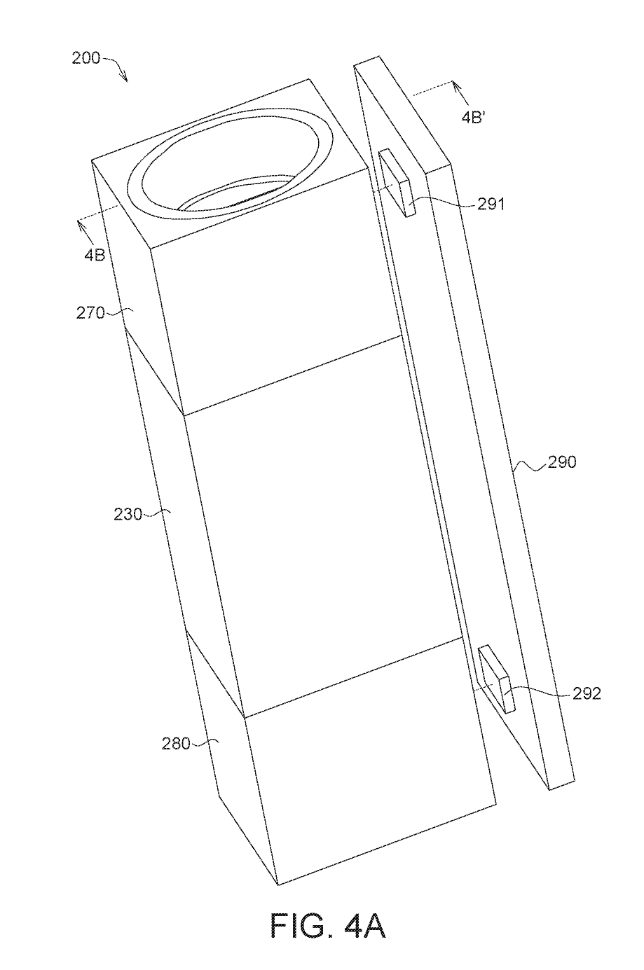

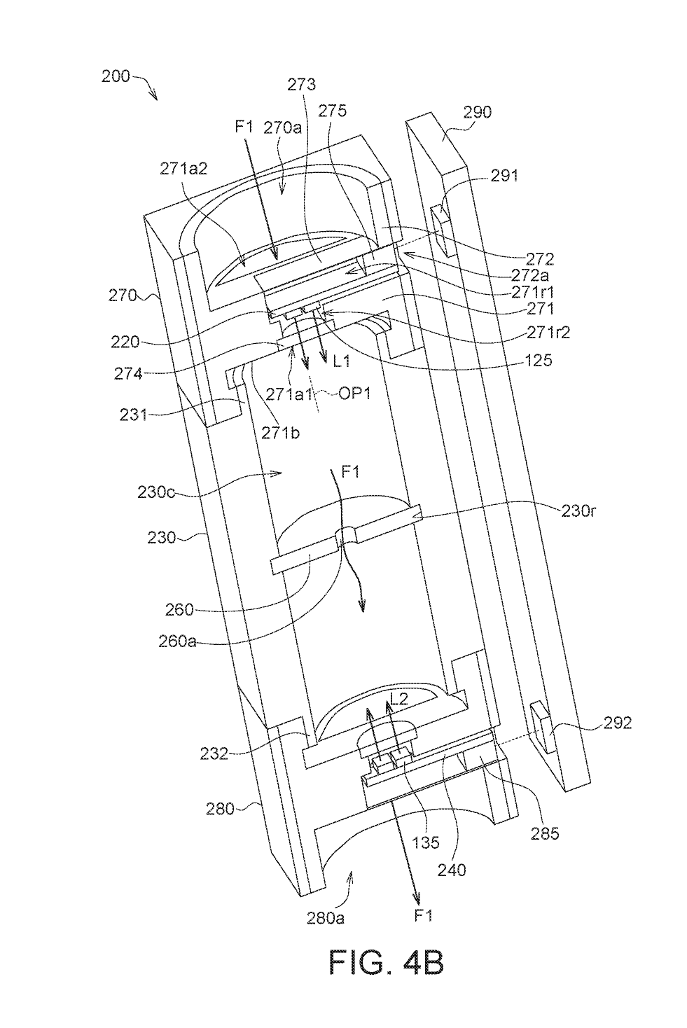

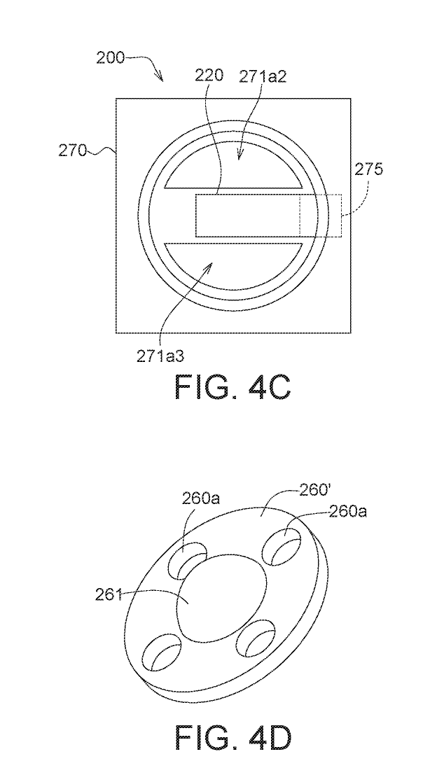

Refer to FIGS. 4A-4D. FIG. 4A shows a schematic diagram of a fluid processing device 200 according to another embodiment of the present disclosure. FIG. 4B shows a cross-sectional view of the fluid processing device 200 of FIG. 4A along a cross-sectional line 4B-4B′. FIG. 4C shows a top view of the fluid processing device 200 of FIG. 4A. FIG. 4D shows a 3D diagram of a flow disturbing component 260′ according to another embodiment of the present disclosure.

The fluid processing device 200 of the present embodiment can be realized by a portable device equipped with an independent electric power supply for the convenience of use.

The fluid processing device 200 includes a fluid sensor 110 (not illustrated), a first circuit board 220, a first light source 125, a reaction chamber body 230, a second light source 135, a second circuit board 240, a controller 150, a flow disturbing component 260, a first adaptor 270, a first connection port 275, a second adaptor 280, a second connection port 285 and a control module 290.

The first adaptor 270 is connected to the reaction chamber body 230 and has a first adaptor opening 270a. The first adaptor 270 can be connected to the first end 231 of the reaction chamber body 230 by way of engaging or bonding, and is interconnected with the reaction chamber 230c of the reaction chamber body 230. The first light source 125 is disposed within the first adaptor 270.

As indicated in FIG. 4B, the first adaptor 270 includes a first bearing wall 271 and a first peripheral wall 272. The first bearing wall 271 connects the inner wall surface of the first peripheral wall 272, and has a first receiving portion 271r1. The first circuit board 220 is disposed within the first receiving portion 271r1. As indicated in the diagram, the fluid processing device 200 further includes a first cover 273 capable of sealing the opening on the first receiving portion 271r1 to avoid the fluid F1 entering through the first adaptor opening 270a to contact the first circuit board 220 within the first receiving portion 271r1 and thus to make the first circuit board 220 short-circuited.

As indicated in FIG. 4B, the first opening 272a is exposed on the first peripheral wall 272 from the first receiving portion 271r1. The first connection port 275 is disposed on the first circuit board 220 and exposed from the first opening 272a. Thus, the first connector 291 of the control module 290 is connected to the first connection port 275 through the first opening 272a and is therefore electrically connected to the first circuit board 220.

As indicated in FIG. 4B, the first bearing wall 271 further has a second receiving portion 271r2 interconnected with the first receiving portion 271r1. The second receiving portion 271r2 is disposed on the bottom surface 271b of the first bearing wall 271 to expose the second opening 271a1. The bottom surface 271b faces a reaction chamber 230c. The first light source 125, disposed on the first circuit board 220 and located at the second receiving portion 271r2, is exposed from the second opening 271a1. Thus, the first light source 125 can emit the first light L1 towards the reaction chamber 230c to sterilize the fluid F1. As indicated in the diagram, the fluid processing device 200 further includes a second cover 274 capable of sealing the second opening 271a1 of the second receiving portion 271r2 to avoid the fluid F1 entering the reaction chamber 230c contacting the first light source 125 of the second receiving portion 271r2 and making the first light source 125 short-circuited. Besides, the second cover 274 can be realized by a translucent cover allowing the first light L1 to pass through.

As indicated in FIGS. 4B and 4C, the first bearing wall 271 of the first adaptor 270 further has a first via 271a2 and a second via 271a3. The first via 271a2 and the second via 271a3 are interconnected with the reaction chamber 230c of the reaction chamber body 230. The fluid F1 of the water source enters the reaction chamber 230c through the first via 271a2 and the second via 271a3 to be sterilized by the first light L1.

As indicated in FIGS. 4B and 4C, the first via 271a2 and the second via 271a3 are respectively disposed on two opposite sides of the first light source 125. The first via 271a2 and the second via 271a3 provide a channel through which the fluid F1 of an external water source enters the reaction chamber 230c. Moreover, after the fluid F1 passes through the first via 271a2 and the second via 271a3, the fluid F1 converges into a single stream fluid F1 and enters the reaction chamber 230c. The single stream fluid F1 is fully sterilized by the first light L1 within the reaction chamber 230c.

As indicated in FIG. 4B, the optical axis OP1 of the first light L1 emitted from the first light source 125 is substantially identical to the extending direction of the reaction chamber body 230 (the same as the flow direction of the fluid F1), therefore the first light L1 can fully sterilize the fluid F1 along its flow direction.

As indicated in FIG. 4B, the second adaptor 280 is connected to the reaction chamber body 130 and has a second adaptor opening 280a. The second adaptor 280 can be connected to the second end 232 of the reaction chamber body 230 by way of engaging or bonding, and is interconnected with the reaction chamber 230c of the reaction chamber body 230. The second light source 135, the second circuit board 240 and the second connection port 285 are disposed within the second adaptor 280, wherein the second light source 135 and the second connection port 285 both are disposed on the second circuit board 240. The second connection port 285 can be connected to the second connector 292 of the control module 290. The structure of the second adaptor 280 is similar or identical to that of the first adaptor 270, and the similarities are not repeated here.

As indicated in FIG. 4B, the optical axis OP2 of the second light L2 emitted from the second light source 135 has a direction substantially inverse to the flow direction of the fluid within the reaction chamber body 230. Therefore, before the fluid F1 exits via the second adaptor 280, the fluid F1 is again sterilized by the second light L2.

The farther away from the light source the optical path of the sterilization light is, the weaker the intensity of irradiation will be. As indicated in FIG. 4B, since two ends of the reaction chamber body 230 of the present disclosure respectively have the first light source 125 and the second light source 135 disposed thereon, the intensity of irradiation is more uniform in the reaction chamber 230c of the reaction chamber body 230 (in comparison to the design in which only one end has the light source). In another embodiment, unless necessary, the fluid processing device 200 can keep only one of the first adaptor 270 and the second adaptor 280 or keep both the first adaptor 270 and the second adaptor 280 but omit the first light source 125 (together with the first circuit board 220) or the second light source 135 (together with the second circuit board 240). Besides, the position of the first light source 125 and the position of the second light source 135 are interchangeable in the fluid processing device 200.

In another embodiment, the first adaptor opening 270a is the fluid inlet. In another embodiment, the fluid processing device 200 can be inverted, that is, the first adaptor opening 270a becomes the fluid outlet. Or, the position of the first adaptor 270 and the position of the second adaptor 280 can be swapped, such that the first adaptor opening 270a becomes the fluid outlet.

As indicated in FIG. 4B, the flow disturbing component 260 can be disposed within the reaction chamber 230c by way of engaging or bonding. For example, the reaction chamber body 230 has an annular engaging groove 230r. The flow disturbing component 260 can be embedded into the engaging groove 230r to be fixed on the reaction chamber body 230. In other embodiment, the reaction chamber 230c can have multiple flow disturbing components 260. Each flow disturbing component 260 has at least one flow disturbing hole 260a. The flow disturbing hole 260a can be located at the central position of the flow disturbing component 260, but the embodiments of the present disclosure are not limited thereto.

As indicated in FIG. 4D, the flow disturbing component 260′ of another embodiment has multiple flow disturbing holes 260a surrounding the central position of the flow disturbing component 260′. Furthermore, the flow disturbing component 260′ further includes a lens portion 261 having a protruded surface, such that when a light passes through the lens portion 261, the light can be focused to increase its directivity.

In other embodiments, the center of the flow disturbing hole 260a can be located at the optical axis of the first light source 125 and/or the second light source 135. Exemplarily but not restrictively, the flow disturbing hole can have a circular shape. The area and position of the flow disturbing hole are designed to allow at least 60% of the light energy of the first light source 125 and/or the second light source 135 to pass through. In an exemplary embodiment, the area and the position of the flow disturbing hole are designed to allow at least 80% of the light energy of the first light source 125 and/or the second light source 135 to pass through. For the fluid F1 to be fully sterilized, the area of the flow disturbing hole is not larger than the irradiation area of the first light source 125 and/or the second light source 135. The flow disturbing hole 260a will disturb the fluid F1 and reduce the flow rate of the fluid F1, so that the fluid F1 can be fully sterilized.

Furthermore, the flow disturbing component 260 can be realized by a translucent plate or an opaque plate. In an embodiment, the flow disturbing component 260 can be formed of quartz.

The fluid sensor 110 can be disposed on the first adaptor 270 or adjacent to the first end 231 (not illustrated) of the reaction chamber body 230. The fluid sensor 110 can detect the passage and flow rate of the fluid F1, so that the first light source 125 can automatically irradiate according to the detected passage and flow rate.

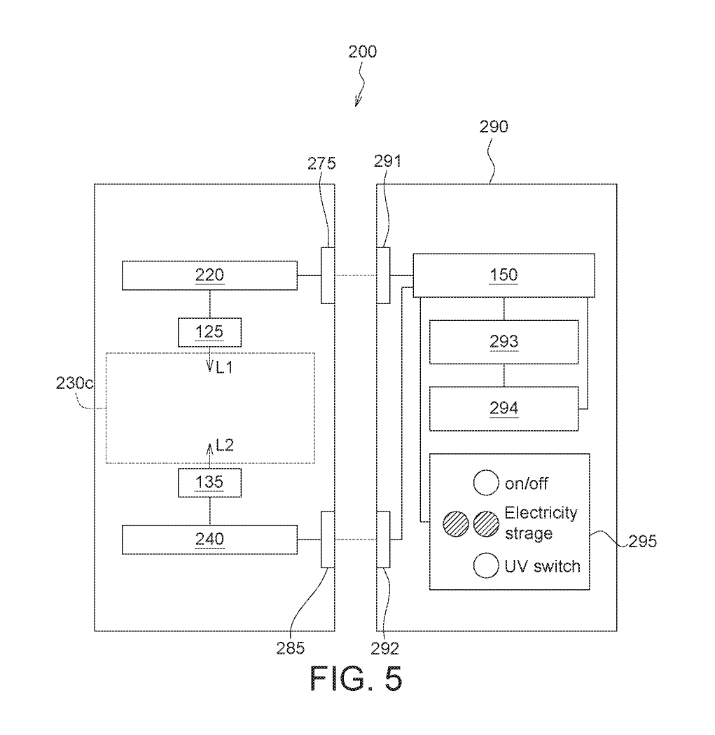

Referring to FIG. 5, a functional block diagram of a fluid processing device 200 according to an embodiment of the present disclosure is shown. The control module 290 of the fluid processing device 200 includes a first connector 291, a second connector 292, a controller 150, an electric power storage device 293, an electric power sensor 294 and a display panel 295. The first connector 291, the second connector 292, the electric power storage device 293, the electric power sensor 294 and the display panel 295 are electrically connected to the controller 150.

When the first connector 291 and the second connector 292 are respectively connected to the first connection port 275 and the second connection port 285, the controller 150 can control the first light source 125 and the second light source 135 to emit the first light L1 and the second light L2 to the reaction chamber 230c, wherein the connection can be an electrical connection adopting pins. Furthermore, the electric power volume necessary for the operation of the controller 150 is provided by the electric power storage device 293. The electric power storage device 293 can either be a detachable type or a non-detachable type. Let the non-detachable type be taken for example, the electric power storage device 293 can be charged through an external electric power (such as AC-grid). The electric power sensor 294 can detect the electric power storage of the electric power storage device 293. The display panel 295 includes at least one indicator, such as an electric power indicator, an electric power storage indicator or a sterilization indicator. The electric power indicator indicates the ON/OFF state of the fluid processing device 200. The electric power storage indicator indicates the electric power storage of the electric power storage device 293. The sterilization indicator indicates whether the fluid processing device 200 is in a sterilization state or a non-sterilization state.

In another embodiment, the fluid processing device 200 can sterilize the fluid F1 without the control module 290.

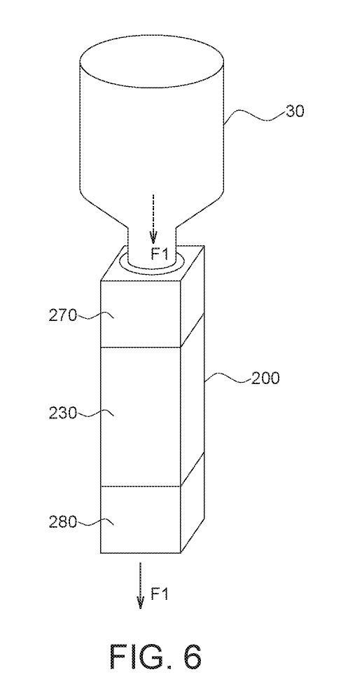

Referring to FIG. 6, a schematic diagram of an application example of a fluid processing device 200 according to an embodiment of the present disclosure is shown. The fluid processing device 200 can be connected to an external water source 30, such as the water within a PET bottle. The first adaptor 270 of the fluid processing device 200 can have a thread structure matching the bottle mouth (not illustrated) of the PET bottle, such that the PET bottle can be easily connected to the fluid processing device 200.

According to the experiment results, after the fluid F1 of the external water source 30 containing an original bacteria count of 1.36×10⁶ flows through the fluid processing device 200 at a flow rate of 1.5 liters per minute (l/min), the residual bacteria count drops to 71,000 and the sterilization rate reaches 94.78%. When the fluid F1 of the external water source 30 containing an original bacteria count of 1.36×10⁶ flows through the fluid processing device 200 at a flow rate of 0.8 l/min, the residual bacteria count drops to 180 and the sterilization rate reaches 99.87%. The experimental results show that the sterilization rate of the fluid processing device 200 is above 90% or even close to 100%.

According to the experiment results, after the fluid F1 of the external water source 30 having an original bacteria count of 1.5×10⁸ passes through the fluid processing device 200 having the flow disturbing component 260 at a flow rate of 2 l/min, the residual bacteria count drops to 16,000 and the sterilization rate reaches 89%. After the fluid F1 of the external water source 30 having an original bacteria count of 1.5×10⁸ passes through the fluid processing device 200 having the flow disturbing component 260 at a flow rate of 2 l/min, the bacteria count drops to 91000 and the sterilization rate reaches 94%. The experimental results show that the fluid processing device 200 having the flow disturbing component 260 has a sterilization rate larger than 90% and can improve the bactericidal effect.

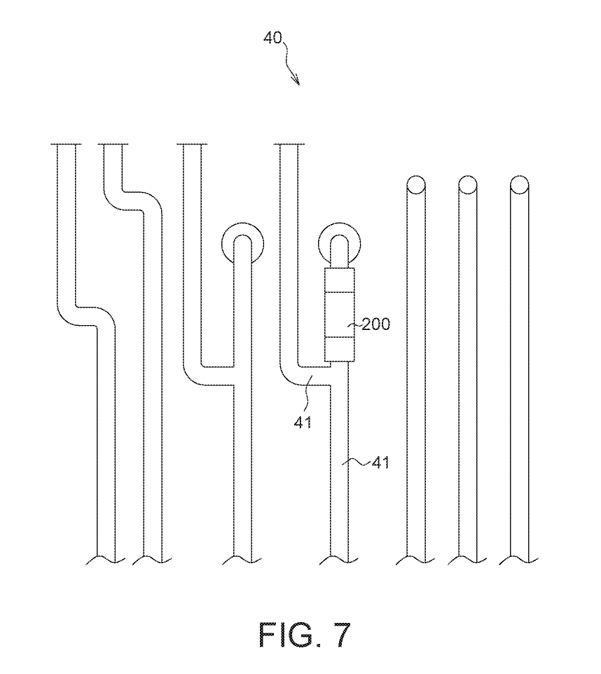

Referring to FIG. 7, a schematic diagram of another application example of a fluid processing device 200 according to another embodiment of the present disclosure is shown. The fluid processing device 200 can be connected to a piping system 40 of a chemical plant. The piping system 40 includes multiple tubular pieces 41 through which the fluid F1 passes. In the present embodiment, the fluid F1 is a working fluid, such as a chemical liquid or a chemical gas. In general, the interior of the tubular pieces 41 needs to be regularly flushed with a bactericidal solution or gas to clean, sterilize and maintain the interior of the tubular pieces 41. In an embodiment of the present disclosure, the fluid processing device 200 can be installed in the tubular pieces 41 of the piping system 40, such that the fluid F1 can be sterilized at any time. Thus, the frequency of bactericidal operation of the tubular pieces 41 can be reduced or saved. In another embodiment, multiple fluid processing devices 200 can be installed in one or more than one tubular piece 41. The present disclosure does not restrict the quantity of the fluid processing devices 200 installed in a tubular piece 41 or the quantity of the tubular pieces 41 equipped with the fluid processing devices 200.

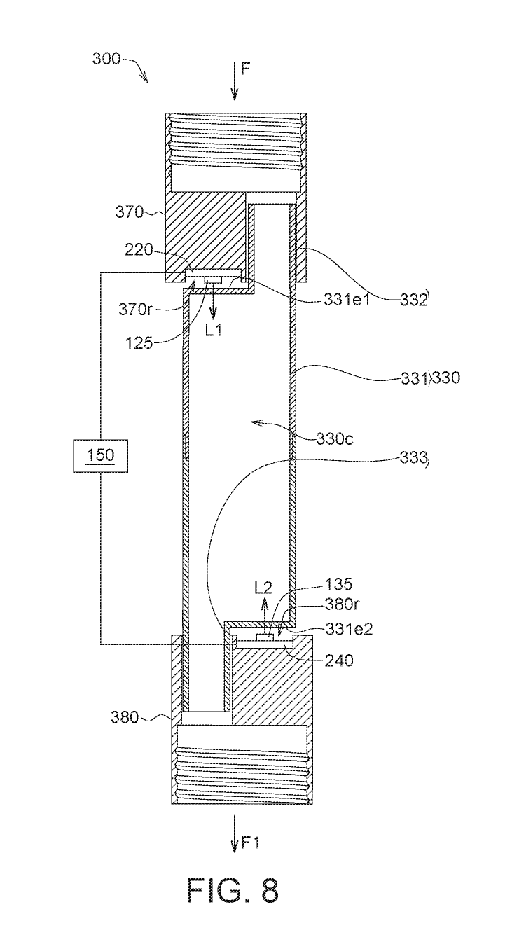

Referring to FIG. 8, a cross-sectional view of a fluid processing device 300 according to another embodiment of the present disclosure is shown. The fluid processing device 300 includes a fluid sensor 110 (not illustrated), a first circuit board 220, a first light source 125, a reaction chamber body 330, a second light source 135, a second circuit board 240, a controller 150, a flow disturbing component 260 (not illustrated), a first adaptor 370 and a second adaptor 380.

The first adaptor 370 is connected to the reaction chamber body 330. The first adaptor 370 has a first receiving portion 370r, a first circuit board 220 and a first light source 125 disposed within the first receiving portion 370r. The first light source 125 is disposed on the first circuit board 220 and is used to emit the first light L1 to the reaction chamber 330c of the reaction chamber body 330.

The second adaptor 380 is connected to the reaction chamber body 330. The second adaptor 380 has a second receiving portion 380r, a second circuit board 240 and a second light source 135 disposed within the second receiving portion 380r. The second light source 135 is disposed on the second circuit board 240 and is used to emit a second light L2 to the reaction chamber 330c of the reaction chamber body 330.

As indicated in FIG. 8, the reaction chamber body 330 includes a main chamber body 331, a first connection chamber body 332 and a second connection chamber body 333 interconnected with each other. The main chamber body 331 has a first end wall 331e1 and a second end wall 331e2 opposite to the first end wall 331e1. The first connection chamber body 332 is protruded outwards from the first end wall 331e1 of the main chamber body 331. The first connection chamber body 332 can be inserted into the first adaptor 370. The first end wall 331e1 of the main chamber body 331 is opposite to the first light source 125, such that the first light L1 can enter the reaction chamber 330c through the first end wall 331e1. Since the first circuit board 220 and the first light source 125 are separated from the reaction chamber 330c, the fluid F1 will not contact the first circuit board 220 and the first light source 125 and make the first circuit board 220 and the first light source 125 short-circuited.

As indicated in FIG. 8, the second connection chamber body 333 is protruded outwards from the second end wall 331e2 of the main chamber body 331. The second connection chamber body 333 can be inserted in the second adaptor 380. The second end wall 331e2 of the main chamber body 331 is opposite to the second light source 135, such that the second light L2 can enter the reaction chamber 330c through the second end wall 331e2. Since the second circuit board 240 and the second light source 135 are separated from the reaction chamber 330c, the fluid F1 will not contact the second circuit board 240 and the second light source 135 and make the second circuit board 240 and the second light source 135 short-circuited.

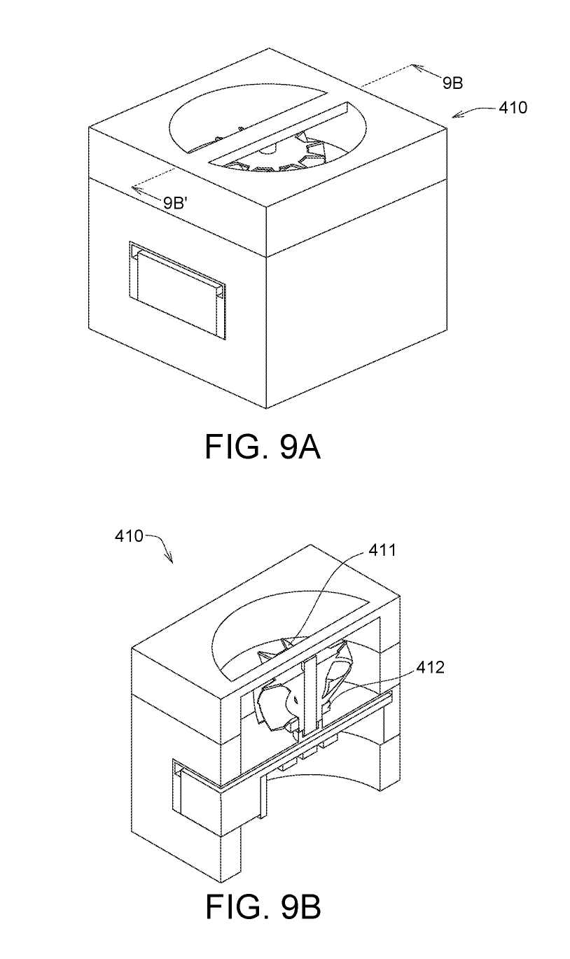

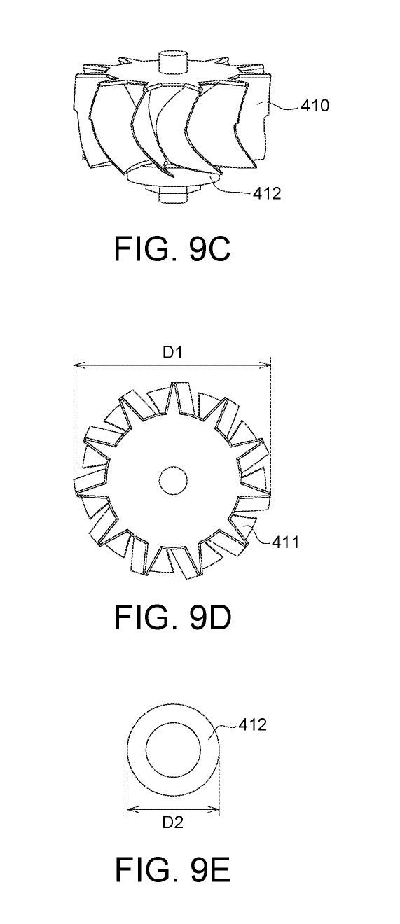

FIG. 9A shows a schematic diagram of a fluid sensor 410 according to another embodiment of the present disclosure, FIG. 9B shows a cross-sectional view of the fluid sensor 410 of FIG. 9A along a direction 9B-9B′, FIG. 9C shows a schematic diagram of the blades 411 of FIG. 9A, FIG. 9D shows a top view of the blades 411 of FIG. 9C, and FIG. 9E shows a top view of the magnet component 412 of FIG. 9C.

The fluid sensor 410 includes blades 411, a magnet component 412 including at least two magnetic poles. The fluid sensor 410 is electrically connected to an electric power generator on a driving circuit. The blades 411 and the magnet component 412 are coaxial. When the fluid flows through the blades 411, the blades 411 and the magnet component 412 rotates and the electric power generator senses the change of magnetic field to generate electric power. The electric power generated by the electric power generator can be provided to drive the at least one light source of the fluid sterilization device. The electric power generator can be a hall effect sensor.

As shown in FIGS. 9D and 9E, a diameter D1 of the blades 411 is not larger than 3 centimeter (cm), and a diameter D2 of the magnet component 412 is not larger than 2 cm.

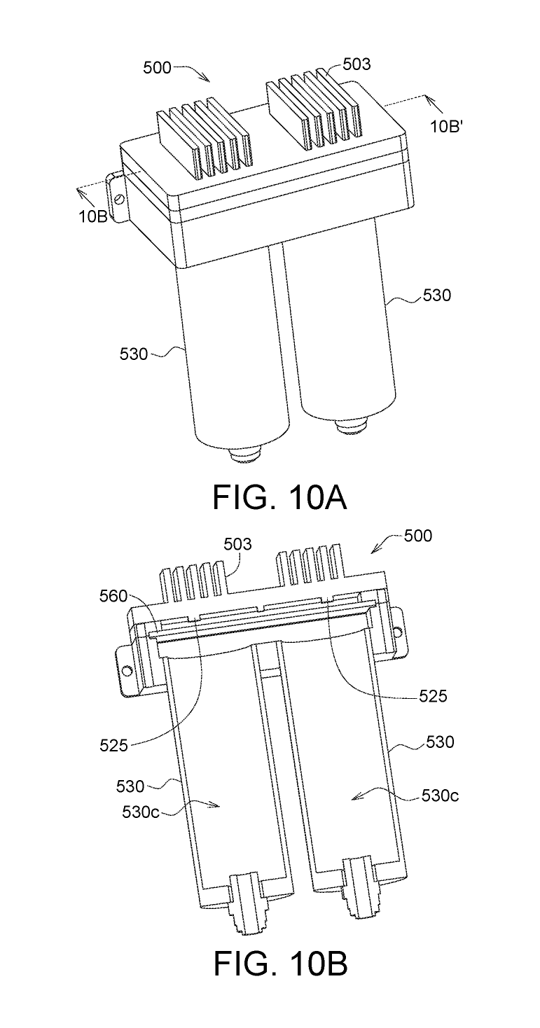

FIG. 10A shows a schematic diagram of a fluid sterilization device 500 according to another embodiment of the present disclosure, and FIG. 10B shows a cross-sectional view of the fluid sterilization device 500 of FIG. 10A along a direction 10B-10B′.

The fluid sterilization device 500 includes at least two light sources 525 on a circuit board, a quartz plate 560, a heat sink 503 and two reaction chamber bodies 530. Each of the two reaction chamber body 530 has a reaction chamber 530c therein to allow fluid to flow. The reaction chamber bodies 530 may be made of a material including, for example, PTFE. The top ends of the reaction chamber bodies 530 can be screwed to connect with the quartz plate 560 and the light sources 525 in fix distances. The light sources 525 are covered by the quartz plate 560 to prevent short-circuit resulted from fluid directly contacting the circuit board and the light source thereon. The light sources 525 can emit sterilization light to the reaction chamber 530c through the quartz plate 560. The fluid enters from the inlet on the bottom end of one of the two reaction chamber body 530 and leaves from the outlet on the bottom end of the other one of the two reaction chamber body 530.

Compared to the fluid sterilization device with single reaction chamber, the fluid sterilization device 500 with two reaction chamber 530c can have higher sterilization rate. For example, when the light dosage is 100 mJ, the sterilization rate is 85% for fluid sterilization device with single reaction chamber. The sterilization rate of the fluid sterilization device 500 with two reaction chamber 530c can reach 99.999% in the same light dosage.

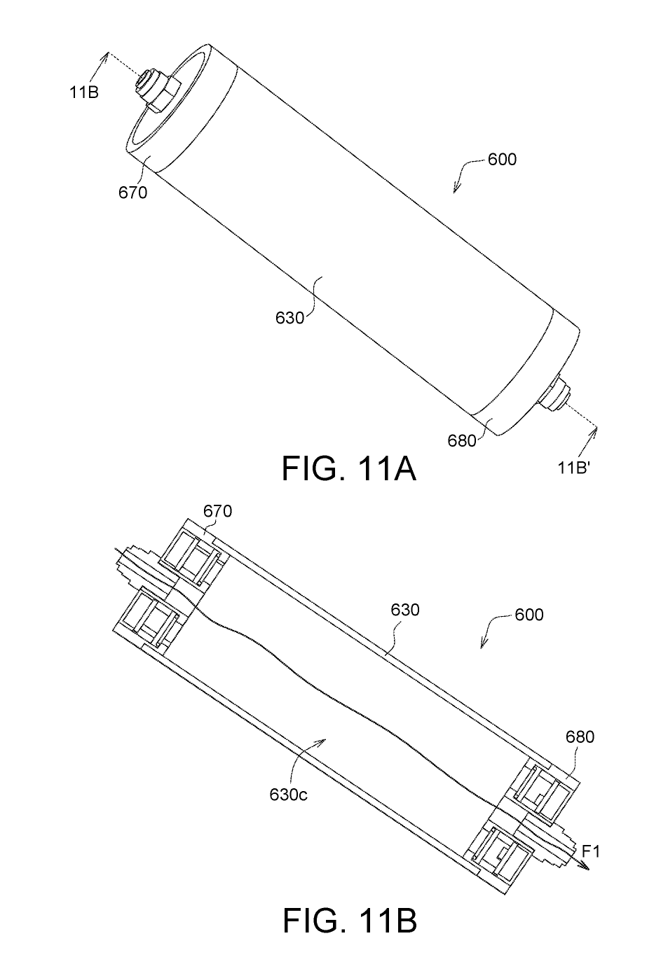

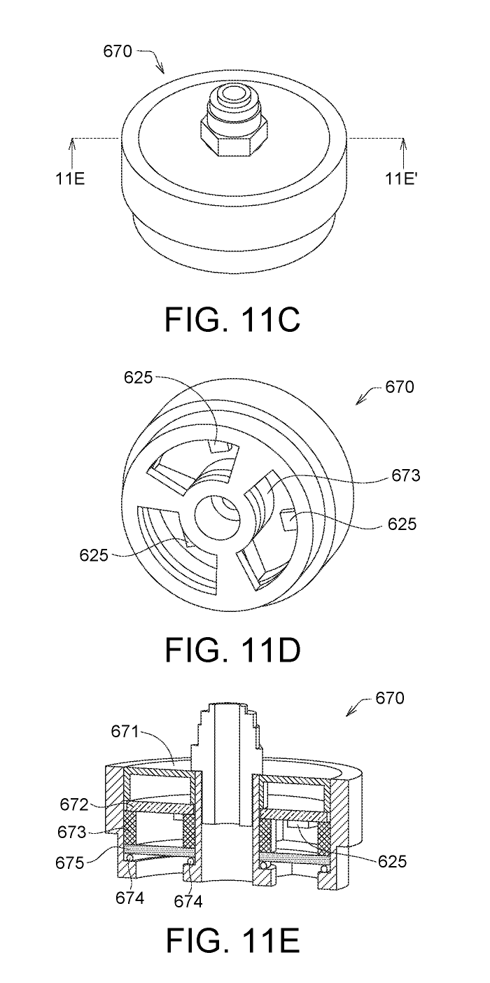

FIG. 11A shows a schematic diagrams of a fluid sterilization device 600 according to another embodiment of the present disclosure, FIG. 11B shows a cross-sectional view of the fluid sterilization device 600 of FIG. 11A along a direction 11B-11B′, FIGS. 11C and 11D show schematic diagrams of the first light-emitting cap 670 of FIG. 11A, and FIG. 11E shows a cross-sectional view of the first light-emitting cap 670 of FIG. 11C along a direction 11E-11E′.

The fluid sterilization device 600 at least includes a reaction chamber body 630, a first light-emitting cap 670 and a second light-emitting cap 680. The first light-emitting cap 670 and the second light-emitting cap 680 are disposed on two ends of the reaction chamber body 630. The fluid F1 may flow through the fluid sterilization device 600 from the first light-emitting cap 670 to the second light-emitting cap 680, or from the second light-emitting cap 680 to the first light-emitting cap 670. The first light sources 625 on the first light-emitting cap 670 can emit first sterilization light toward the reaction chamber 630c. The second light sources on the second light-emitting cap 690 can emit second sterilization light toward the reaction chamber 630c. Therefore, the fluid passing through the reaction chamber 630c can be sterilized twice by the light coming from both the first light-emitting cap 670 and the second light-emitting cap 680. In addition, the first light-emitting cap 670 and the second light-emitting cap 680 can be quickly screw on the reaction chamber body 630 or be quick release therefrom.

As shown in FIGS. 11D and 11E, the first light-emitting cap 670 includes a top cover 671, at least one light source 625, a circuit board 672, a gasket 673, at least one O-ring 674 and a quartz plate 675.

A plurality of light sources 625 disposed on the circuit board 672 emit light passing through the quartz plate 675. The light sources 625 are arranged in at least one concentric circle around the edge of the first light-emitting cap 670. The light sources 625 emit sterilization light through the quartz plate 675. When the first light-emitting cap 670 is screw on the reaction chamber body 630, the gasket 673 is used to apply pressure to cause the O-ring 674 below the quartz plate 675 to be deformed therefore the quartz plate 675 can tightly seal the reaction chamber 630c to prevent fluid F1 to contact the light sources 625 on the circuit board 672.

In addition, the second light-emitting cap 680 has features similar to or the same as the first light-emitting cap 670, and the similarities are repeated here.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A fluid sterilization device, comprising:
a reaction chamber body having a reaction chamber, a first end and a second end, wherein the reaction chamber allows fluid to pass through;
a first light source located at the first end of the reaction chamber to emit a first sterilization light to the reaction chamber;
a fluid sensor used to detect the passage and flow rate of the fluid and accordingly output a signal; and
a controller used to control the first light source to emit the first sterilization light and control intensity of the first sterilization light in response to the signal.

2. The fluid sterilization device according to claim 1, further comprising:
a first heat conduction component formed of metal; and
a first circuit board connected to the first heat conduction component;
wherein the first light source is disposed on the first circuit board.

3. The fluid sterilization device according to claim 1, wherein optical axis of the first sterilization light emitted from the first light source has a direction substantially parallel to extending direction of the reaction chamber body.

4. The fluid sterilization device according to claim 1, wherein the fluid sterilization device further comprises a second light source located at the second end of the reaction chamber and configured to emit a second sterilization light to the reaction chamber.

5. The fluid sterilization device according to claim 4, further comprising:
a second heat conduction component formed of metal; and
a second circuit board connected to the second heat conduction component;
wherein the second light source is disposed on the second circuit board.

6. The fluid sterilization device according to claim 1, further comprising:
a first lens constituting an end wall of the first end of the reaction chamber body.

7. The fluid sterilization device according to claim 1, further comprising:
at least one flow disturbing component disposed within the reaction chamber and having at least one flow disturbing hole.

8. The fluid sterilization device according to claim 7, wherein the flow disturbing hole is located at the middle of the flow disturbing component and has an area not larger than a light irradiation area of the first light source.

9. The fluid sterilization device according to claim 7, wherein the flow disturbing component has a plurality of flow disturbing holes disposed around the center of the flow disturbing component.

10. The fluid sterilization device according to claim 7, wherein the flow disturbing component comprises a lens portion configured to focus the light when it passing through the lens portion.

11. The fluid sterilization device according to claim 1, further comprising:
a light intensity sensor configured to detect the intensity of the first sterilization light.

12. The fluid sterilization device according to claim 11, further comprising:
a display panel on which detection results of the fluid sensor and the light intensity sensor are displayed by the controller.

13. The fluid sterilization device according to claim 1, further comprising:
a control module comprising the controller, an electric power storage device, an electric power sensor, a display panel and at least one connector, wherein the at least one connector of the control module is correspondingly connected to at least one connection port of the fluid sterilization device so that the control module is electrically connected to the at least one connection port.

14. The fluid sterilization device according to claim 1, wherein the controller wirelessly transmits message of the fluid sterilization device to a display panel of a computer or a mobile phone.

15. The fluid sterilization device according to claim 1, wherein the controller stores data of flow rate of the fluid, the intensity of the first sterilization light and sterilization rate of the fluid sterilization device to calculate the flow rate of the fluid and the intensity that are required to achieve a fixed sterilization rate.

16. The fluid sterilization device according to claim 1, wherein data of flow rate of the fluid, the intensity of the first sterilization light and sterilization rate of the fluid sterilization device are collected and stored at a cloud processor, and the cloud processor, utilizes stored big data to calculate the flow rate of the fluid and the intensity that are required to achieve a fixed sterilization rate.

17. The fluid sterilization device according to claim 1, further comprising:
an electric power storage device configured to provide a necessary electric power to the first light source.

18. The fluid sterilization device according to claim 17, wherein the electric power storage device is a solar cell configured to convert light of solar energy into electric power and store the electric power in the electric power storage device.

19. The fluid sterilization device according to claim 17, further comprising:
an electric power generator configured to generate electric power and store the electric power in the electric power storage device.

20. A water purifier, comprising at least two fluid sterilization devices according to claim 1, wherein after the fluid is sterilized by one of the fluid sterilization devices, the fluid is filtered by a filter cartridge, and the filtered fluid flows through another fluid sterilization device.
